(19) United States
(12) Patent Application Publication
(10) Pub. No.: US 2026/0287409 A1
(43) Pub. Date: Sep. 24, 2026

(54) APPARATUS FOR DETECTING REMAINING AMOUNT OF DETERGENT IN WASHING MACHINE

(71) Applicant: Yun Chan KIM, Hwaseong-si, Gyeonggi-do (KR)

(72) Inventor: Yun Chan KIM, Hwaseong-si, Gyeonggi-do (KR)

(21) Appl. No.: 19/490,937

(22) PCT Filed: May 31, 2024
(86) PCT No.: PCT/KR2024/007511

§ 371 Date: Dec. 7, 2025

(30) Foreign Application Priority Data
Jun. 7, 2023 (KR) 10-2023-0072906

(51) Int. Cl. G01F 23/24; D06F 39/02; D06F 103/22

(52) U.S. Cl. CPC G01F 23/24; D06F 39/022; D06F 2103/22

(57) ABSTRACT

The present inventive concept relates to an apparatus for detecting the remaining amount of detergent in a washing machine, wherein the apparatus detects the remaining amount of detergent filled in a detergent tank and provides information about the number of washing cycles available afterwards. The apparatus for detecting the remaining amount of detergent in a washing machine comprises: a pair of electrode sensing means installed in a detergent tank to be impregnated with detergent; and a control unit that supplies current to the pair of electrode sensing means, extracts the remaining amount of detergent by using a change in electrical characteristics measured between the pair of electrode sensing means according to the level of the detergent, and provides the remaining amount of detergent to a display unit, wherein at least one of the pair of electrode sensing means is composed of a resistance electrode rod, and the resistance electrode rod is composed of an electrode rod formed of a single material having a certain resistance or an electrode rod formed of a composite material that is obtained by mixing an insulating material and a conductive material and has a certain resistance.

### TECHNICAL FIELD

The present inventive concept relates to an apparatus for detecting the remaining amount of detergent in a washing machine, more particularly to an apparatus for detecting the remaining amount of detergent in a washing machine that is capable of detecting the remaining amount of detergent in a detergent tank of the washing machine and providing information of the number of washing cycles available afterwards.

### BACKGROUND ART

Generally, washing machines are devices that typically use the emulsifying action of detergent, the friction among water currents generated from the rotations of a washing machine tub, and agitation applied from the washing machine tub to the laundry to remove various types of pollutants from laundry. The washing machines are largely classified into pulsator washing machines that perform washing by means of water currents generated by the rotations of a plate-shaped pulsator and drum washing machines that perform washing by means of drop differences and friction between washing water supplied to the inside of a drum and laundry according to the rotations of the drum.

Recently, fully automatic washing machines, which automatically perform the entire process of washing, rinsing, and spinning, have been introduced so that a user's control during the entire process is not needed at all. To do this, the washing machine is provided with a detergent supply device that automatically supplies a proper amount of detergent according to an amount of laundry, and if wash water is supplied to a washing machine tub, the detergent supply device operates to supply the detergent into the tub in a mixed state with the wash water.

Laundry detergents are commonly available in solid-phase powder and liquid forms, and detergent supply configurations of washing machines may be varied according to the types of detergent used.

The washing machine using liquid detergent is freer in installation position of the detergent supply device than the washing machine using powder detergent. In detail, the powder detergent is not easy to move upward so that the installation position of the detergent supply device of the washing machine using the powder detergent is limitedly determined on top of the tub, but it is possible to move the liquid detergent upward by means of a device such as a pump for forcibly flowing a fluid so that the detergent supply device of the washing machine using the liquid detergent may be located on the underside of the tub. Therefore, the washing machine using liquid detergent is freer in arrangements of parts than the washing machine using powder detergent.

Further, an amount of powder detergent supplied is not easy to be adjusted so that in the case of the washing machine using powder detergent, a proper amount of detergent according to an amount of laundry has to be supplied directly by a user whenever washing. In the case of the washing machine using liquid detergent, contrarily, an amount of detergent to be supplied can be easily adjusted if a flow regulator is used so that after a large amount of detergent has been stored once in the washing machine using liquid detergent, a given amount of detergent is automatically supplied into the tub whenever washing.

Further, the washing machine using liquid detergent has the above-mentioned excellent advantages when compared with the washing machine using powder detergent, but there are many inconveniences in frequently checking the remaining amount of detergent in the washing machine. If the remaining amount of detergent in the washing machine is not sufficient to wash laundry, the laundry washing is not smoothly done.

To solve such conventional problems, a device and method for detecting the remaining amount of liquid detergent in a washing machine is disclosed in Korean Patent Application Laid-open No. 10-2011-0004748 (which is referred to as Patent document 1). The device of the Patent document 1 has a pair of electrode rods disposed in a liquid detergent tank in such a way as to allow end portions thereof to be located at different heights from the bottom of the liquid detergent tank, and if liquid detergent is not detected from both of the electrode rods, a control unit determines that the remaining amount of liquid detergent in the washing machine is not sufficient for washing. In detail, the device of the Patent document 1 only detects a state in which the liquid detergent is low to a given level or under, that is, the existence/non-existence of liquid detergent, so that it fails to detect the exact remaining amount of liquid detergent, that is, the current level of liquid detergent remaining in the liquid detergent tank. As a result, a user cannot recognize whether how many washing cycles are available by using the leftover liquid detergent after the current washing cycle.

### DISCLOSURE

### Technical Problem

Accordingly, the present inventive concept has been made in view of the above-mentioned problems occurring in the related art, and it is an object of the present inventive concept to provide an apparatus for detecting the remaining amount of detergent in a washing machine that is capable of detecting the remaining amount of liquid detergent in a detergent tank of the washing machine in real time.

It is another object of the present inventive concept to provide an apparatus for detecting the remaining amount of detergent in a washing machine that is capable of providing information of the number of washing cycles available afterwards for a user, based on the information of the remaining amount of liquid detergent detected thereby.

The technical problems to be achieved through the present inventive concept are not limited as mentioned above, and other technical problems not mentioned herein will be obviously understood by one of ordinary skill in the art through the following description.

### Technical Solution

To accomplish the above-mentioned objects, according to the present inventive concept, there is provided an apparatus for detecting the remaining amount of detergent in a washing machine, the apparatus including: a pair of electrode sensing means disposed in a detergent tank in such a way as to be submerged in the detergent; and a control unit for supplying an electric current to the pair of electrode sensing means, extracting the remaining amount of detergent in the detergent tank from a change in electrical characteristics measured between the pair of electrode sensing means according to the level of the detergent, and providing information of the remaining amount of detergent extracted to a display unit, wherein at least one of the pair of electrode sensing means is a resistance electrode rod that is formed of an electrode rod made of a single material having a certain resistance or an electrode rod made of a composite material having a certain resistance, the composite material being obtained by mixing an insulating material and a conductive material.

Further, the control unit may extract information of the number of washing cycles available afterwards according to the extracted information of the remaining amount of detergent and provide the extracted information of the number of washing cycles available afterwards to the display unit.

Furthermore, the resistance electrode rod may be made of a material having an electrical resistance between 10 Ω and 100 MΩ.

Moreover, the electrode sensing means may have end portions located at the same height as each other in such a way as to be spaced apart from the bottom of the detergent tank by a given distance.

Besides, the electrode sensing means may have end portions located at different heights in such a way as to be spaced apart from the bottom of the detergent tank distant by given distances.

### Advantageous Effects of Inventive Concept

The apparatus for detecting the remaining amount of detergent in a washing machine according to the present inventive concept detects the current remaining amount of detergent in the detergent tank and thus provides the information of the remaining amount of detergent for the user in real time.

Additionally, the apparatus for detecting the remaining amount of detergent in a washing machine according to the present inventive concept provides the information of the number of washing cycles available afterwards, based on the information of the current remaining amount of detergent, thereby greatly improving the conveniences of use.

### BRIEF DESCRIPTION OF DRAWINGS

FIG. 1 shows the main parts of an apparatus for detecting the remaining amount of detergent in a washing machine according to an embodiment of the present inventive concept.

FIG. 2 shows examples wherein the remaining amounts of detergent are detected according to the embodiment of the present inventive concept.

FIG. 3 shows a variation of the apparatus for detecting the remaining amount of detergent in a washing machine according to the embodiment of the present inventive concept.

### MODE FOR INVENTIVE CONCEPT

The present inventive concept and the technical solutions accomplished by carrying out the present inventive concept will become apparent from embodiments of the present inventive concept as will be discussed later. Hereinafter, an explanation of the embodiments of the present inventive concept will be given in detail with reference to the attached drawings.

Further, it should be understood that differences in the embodiments of the present inventive concept are not mutually exclusive. In detail, the particular features, structures, or characteristics in one or more embodiments may be combined in any suitable manner, within the idea and technical scope of the present inventive concept, and positions or arrangements of the components described in the respective embodiments may be changed. In the description, it should be noted that the parts corresponding to those of the drawings are indicated by corresponding reference numerals, and lengths, dimensions, thicknesses, and shapes may be exaggerated for clarity of illustration. Also, in explaining elements, terms like “first”, “second”, etc. may be used to distinguish one from the others only, so that their technical meaning may not be limited by their lexical meaning.

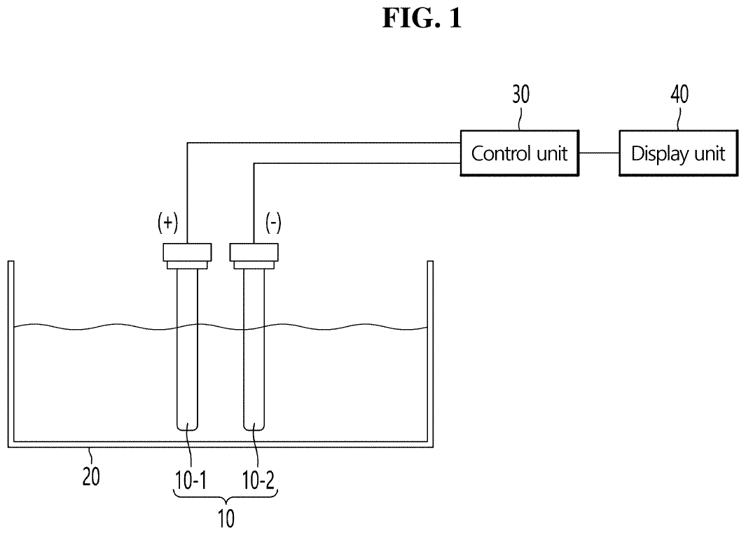

FIG. 1 shows the main parts of an apparatus for detecting the remaining amount of detergent in a washing machine according to an embodiment of the present inventive concept.

Referring to FIG. 1, an apparatus for detecting the remaining amount of detergent in a washing machine according to an embodiment of the present inventive concept includes a pair of electrode sensing means 10 disposed in a detergent tank 20, a control unit 30 connected to the pair of electrode sensing means 10 to detect the remaining amount of detergent in the detergent tank 20 and thus extract the information of the number of washing cycles available afterwards, and a display unit 40 for displaying the remaining amount of detergent and the information of the number of washing cycles available afterwards that are detected and extracted by the control unit 30.

The electrode sensing means 10 are submerged in the detergent stored in the detergent tank 20 and thus serve to detect the remaining amount of detergent in the detergent tank 20. The electrode sensing means 10 are resistance electrode rods serving as electrodes having a given resistance in the form of a rod having a given diameter and length. The electrode sensing means 10 include a first electrode sensing means 10-1 that is located at one side of the detergent tank 20 and serves as a positive (+) terminal and a second electrode sensing means 10-2 that is located at the other side of the detergent tank 20 and serves as a negative (−) terminal.

The electrode sensing means 10 are spaced apart from each other by a given distance and allow the end portions thereof to be located at a given height spaced apart from the bottom of the detergent tank 20 by a given distance, that is, at a given height at which the liquid detergent is used to an amount less than the reference amount thereof so that the detergent tank 20 has to be refilled with detergent.

Each electrode sensing means 10 is a resistance electrode rod made of a single material having a given resistance according to the inherent characteristics of the material or a resistance electrode rod made of a composite material that is obtained by mixing an insulating material and a conductive material at given ratios and has a given resistance. If the electrode sensing means 10 is made of a conductive material that allows an electric current to flow easily through it or an insulating material that does not allow an electric current to flow through it, electrical characteristics, such as the size of an electric current or resistance, between the electrode sensing means 10 are not changed even in the case where the level of liquid detergent is varied, thereby failing to detect the remaining amount of detergent in the detergent tank 20.

According to the embodiment of the present inventive concept, the electrode sensing means 10 have an electrical resistance between 10 Ω and 100 MΩ (100,000,000 Ω). If the electrode sensing means 10 have the electrical resistance less than 10 Ω or greater than 100 MΩ, changes in the electrical characteristics that are generated according to the changes in the level of detergent may be slight, which lowers the degree of accuracy in the detection of the remaining amount of detergent. Under the condition where the electrode sensing means 10 have an electrical resistance between 10 Ω and 100 MΩ, therefore, changes in the electrical characteristics that are generated according to the changes in the level of liquid detergent are easily measured, thereby improving the degree of accuracy in the detection of the remaining amount of detergent.

According to the embodiment of the present inventive concept, further, both of the electrode sensing means 10 are the resistance electrode rods, but of course, it is possible that at least any one of both electrode sensing means 10 may be the resistance electrode rod. In detail, one side electrode rod may be the resistance electrode rod, and the other side electrode rod may be a conductive electrode rod.

The detergent tank 20, which is configured to be filled with the laundry detergent, has a given size and is mounted on the washing machine, which is well known in the conventional practices.

The control unit 30 supplies power to the pair of electrode sensing means 10 and thus extracts the remaining amount of detergent in the detergent tank 20 from the information of an electric current or resistance detected by the pair of electrode sensing means 10. To do this, the control unit 30 includes a power supply module and a remaining amount extraction module.

If the power is supplied to the liquid detergent through the pair of electrode sensing means 10, it flows along the surface of one side first electrode sensing means 10-1, the surface of the liquid detergent filled in the detergent tank 20, and the surface of the other side second electrode sensing means 10-2. The control unit 30 extracts the remaining amount of liquid detergent according to the electrical characteristics measured between the first electrode sensing means 10-1 and the second electrode sensing means 10-2.

Further, the control unit 30 extracts the number of washing cycles available afterwards according to the information of the remaining amount of liquid detergent. To do this, the control unit 30 further includes a washing information prediction module. After one time washing cycle is performed in a state where the liquid detergent is completely filled in the detergent tank 20, that is, at a maximum level of liquid detergent, the control unit 30 compares an amount of detergent consumed with the remaining amount of detergent and then extracts the number of washing cycles available afterwards according to the information obtained through the comparison. The amounts of liquid detergent needed are varied according to amounts of laundry, but through programmed repetition learning, the number of washing cycles available afterwards with respect to a given amount of laundry can be extracted.

The control unit 30 is provided as a Programmable Logic Controller (PLC) that is programmed to control certain processes, and the remaining amount information and the information of the number of washing cycles available afterwards, which are extracted through the control unit 30, are provided to the display unit 40.

The display unit 40 displays the remaining amount information and the information of the number of washing cycles available afterwards that are received from the control unit 30 and allows them to be checked by the user. To do this, the display unit 40 includes a display module, which can be used as a display module that is mounted on conventional washing machines.

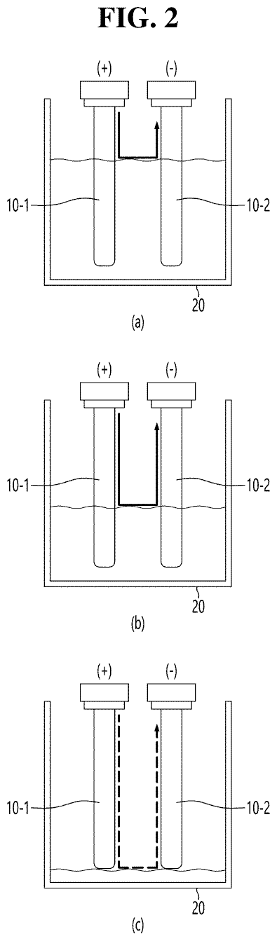

FIG. 2 shows examples wherein the remaining amounts of detergent are detected according to the embodiment of the present inventive concept.

Referring to FIG. 2, processes of detecting the remaining amount of detergent will be described. As shown in FIG. 2a, first, the pair of electrode sensing means 10 is exposed by a relatively short length to the outside in a state where a level of liquid detergent is relatively high, and in this case, the electric current flows along a relatively short route formed over the surface of the first electrode sensing means 10-1, the surface of the liquid detergent, and the surface of the second electrode sensing means 10-2. In this case, since the exposed region of the pair of electrode sensing means 10 has a relatively low resistance, the control unit 30 measures a relatively high electric current between the first electrode sensing means 10-1 and the second electrode sensing means 10-2.

As shown in FIG. 2b, next, the pair of electrode sensing means 10 is exposed by a relatively long length to the outside in a state where a level of liquid detergent is relatively low, and in this case, the electric current flows along a relatively long route formed over the surface of the first electrode sensing means 10-1, the surface of the liquid detergent, and the surface of the second electrode sensing means 10-2. In this case, since the exposed region of the pair of electrode sensing means 10 has a relatively high resistance, the control unit 30 measures a relatively low electric current between the first electrode sensing means 10-1 and the second electrode sensing means 10-2.

The level of liquid detergent, that is, the remaining amount of liquid detergent in the detergent tank 20 is extracted according to the electrical characteristics measured based on the exposed length to the outside of the pair of electrode sensing means 10.

As shown in FIG. 2c, further, the pair of electrode sensing means 10 and the liquid detergent are physically separated from each other in a state where a level of liquid detergent is lower than the end portions of the electrode sensing means 10, and in this case, the electric current does not flow. In this case, the control unit 30 produces information of liquid detergent refill and provides the information to the display unit 40.

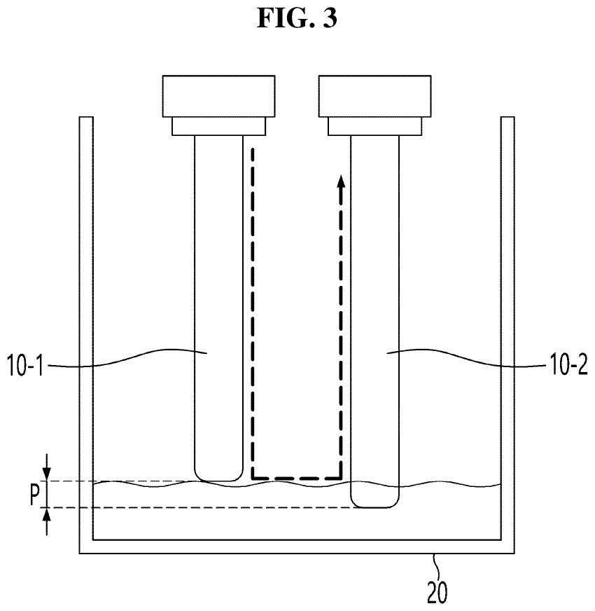

FIG. 3 shows a variation of the apparatus for detecting the remaining amount of detergent in a washing machine according to the embodiment of the present inventive concept.

In the case of the variation of the apparatus of the present inventive concept, the electrode sensing means 10 have end portions located at different heights from the bottom of a detergent tank 20. For example, the end portion of the first electrode sensing means 10-1 is located at a height distant by a given distance P from the end portion of the second electrode sensing means 10-2.

Generally, the liquid detergent is viscous so that even if a level of liquid detergent is lower than the end portions of the electrode sensing means 10, the liquid detergent is connected to the electrode sensing means 10 to allow an error in which the detergent refill information is not produced to be present. To prevent such an error from being present, the end portion of one side electrode sensing means 10 is located at a relatively higher position than that of the other side electrode sensing means 10.

The present inventive concept provides the apparatus for detecting the remaining amount of detergent in a washing machine, but of course, the present inventive concept may be utilized even in a technology in which amounts of material used in other products are detected based on electrical characteristics. Further, the present inventive concept detects the remaining amount of liquid detergent in a washing machine, but of course, the present inventive concept detects the remaining amount of powder detergent, gel detergent, and ice-like solid detergent only if they are conductive. Furthermore, the present inventive concept detects the remaining amount of liquid detergent, but of course, the present inventive concept detects the remaining or used amounts of other conductive materials capable of utilizing their electrical characteristics.

Although specific embodiments have been illustrated and described herein, it will be appreciated by those of ordinary skill in the art that various variations and other embodiments may be substituted for the specific embodiment shown. This application is intended to cover any variations and other embodiments of the present inventive concept. Therefore, it is manifestly intended that this inventive concept be limited only by the claims and the equivalents thereof.

1. An apparatus for detecting the remaining amount of detergent in a washing machine, the apparatus comprising:
a pair of electrode sensing means disposed in a detergent tank in such a way as to be submerged in the detergent; and
a control unit for supplying an electric current to the pair of electrode sensing means, extracting the remaining amount of detergent in the detergent tank from a change in electrical characteristics measured between the pair of electrode sensing means according to the level of the detergent, and providing information of the remaining amount of detergent extracted to a display unit,
wherein at least one of the pair of electrode sensing means is a resistance electrode rod that is formed of an electrode rod made of a single material having a certain resistance or an electrode rod made of a composite material having a certain resistance, the composite material being obtained by mixing an insulating material and a conductive material.

2. The apparatus according to claim 1, wherein the control unit extracts information of the number of washing cycles available afterwards according to the extracted information of the remaining amount of detergent and provides the extracted information of the number of washing cycles available afterwards to the display unit.

3. The apparatus according to claim 1, wherein the resistance electrode rod is made of a material having an electrical resistance between 10 Ω and 100 MΩ.

4. The apparatus according to claim 1, wherein the electrode sensing means have end portions located at the same height as each other in such a way as to be spaced apart from the bottom of the detergent tank by a given distance.

5. The apparatus according to claim 1, wherein the electrode sensing means have end portions located at different heights in such a way as to be spaced apart from the bottom of the detergent tank distant by given distances.
